(19) United States
(12) Patent Application Publication
(10) Pub. No.: US 2010/0244479 A1
(43) Pub. Date: Sep. 30, 2010

(54) SLIDING BAR ASSEMBLY FOR USE IN CARGO STORAGE APPLICATIONS

(75) Inventor: Gayle D. Goodrich, Fort Wayne, IN (US)

Correspondence Address: International Truck Intellectual Property Company,, 4201 WINFIELD ROAD, WARRENVILLE, IL, 60555, US

(73) Assignee: International Truck Intellectual Property Company, LLC, Warrenville, IL (US)

(21) Appl. No.: 12/410,715

(22) Filed: Mar. 25, 2009

(51) Int. Cl. B60R 7/04; B60P 3/42

(52) U.S. Cl. 296/37.8; 296/24.33

(57) ABSTRACT

A sliding bar assembly (100) for use in cargo storage applications includes end caps (209, 211) that are used to provide support for a support bar (201, 203) extending between the end caps (209, 211). A retaining member (205) is attached to one or more of the support bars (201, 203) for retaining cargo within a storage area located behind the retaining member. The end caps (209, 211) further include a channel track (307) that is used for guiding the support bar (201, 203) between a substantially raised position and substantially lowered position.

### BACKGROUND

Embodiments disclosed herein relate generally to cargo storage and more particularly to a slide bar and net assembly used for cargo storage in vehicular applications.

Many different types and styles of storage systems are used in connection with vehicular cargo storage which is sometimes called an “airline” storage bin. In storing large and/or heavy items, it is important to secure these objects so that the cargo is prevented from moving or shifting positions. This is particularly true in truck and automotive storage where the cargo shifts in the event of a sudden stop.

In order to prevent the cargo from shifting, a net can be used to prevent cargo from moving beyond some predetermined location. If bags, parcels, or other objects are stored in a predefined area, a net or net-like material can be stretched between two points that works to prevent the parcel from shifting or moving during transport. Prior art FIG. 1 illustrates a storage bin 100 as used in an typical “over-the-seat” type storage bin in a typical application. The storage bin 100 includes one or more support bars 101 that are frictionally engaged within a bracket 103 formed in an end cap at both sides of the storage compartment or bin. The support bar 101 is threaded through the net 107 allowing the net 107 to hang from the support bar 101. One or more stretchable cords 109 are used to fasten the net to a fixed object that allows it to be retained under tension into a fixed position.

To access the bin or storage area, bags, boxes, suitcases, or other cargo must be lifted above and over the support bar 101. Although this type of device has great utility, the bar can be an obstacle for the user, preventing easy access into the bin.

### SUMMARY

Embodiments described herein relate to a vehicular retaining bar storage bin assembly for use in retaining objects within a storage area. One embodiment includes at least one support bar that uses end caps positioned at the end support bar for providing a fastening area. Each end cap includes one or more channel tracks that are molded therein for guiding a support bar between a substantially raised position and a substantially lowered position. A net or other retaining member is used for retaining cargo within the storage area behind the net. A support stop is located at an upper end of the channel track for allowing the support bar to be retained in the substantially raised position.

### BRIEF DESCRIPTION OF THE FIGURES

FIG. 1 is a perspective view of a prior art net and bar used in airline cargo storage.

FIG. 2 is an exploded view illustrating the sliding bar and net assembly in accordance with embodiments described herein.

FIG. 3 is a front view of an end cap used with the sliding bar assembly in accordance with embodiments described herein.

FIG. 4 is front view of an end cap used with the sliding bar assembly in accordance with embodiments described herein.

FIG. 5 is a perspective view illustrating the sliding bar and net assembly shown in a closed position in accordance with embodiments described herein.

FIG. 6 is a perspective view illustrating the sliding bar and net assembly shown in an open position in accordance with embodiments described herein.

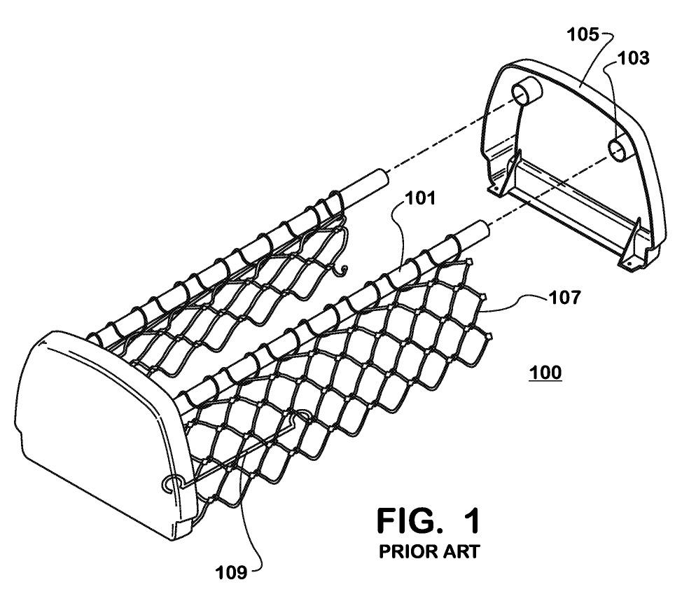

### DETAILED DESCRIPTION

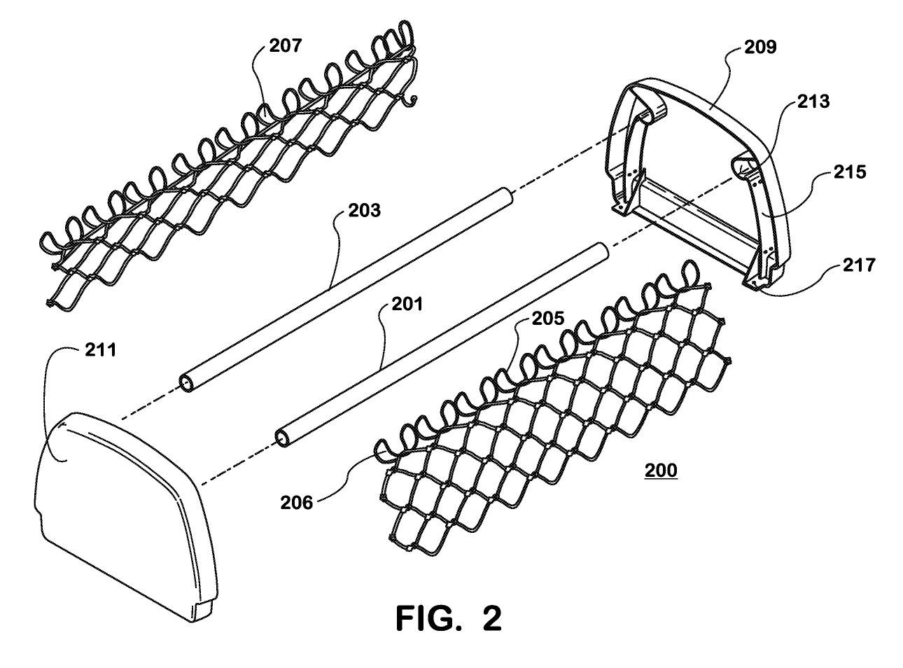

FIG. 2 is an exploded view illustrating the sliding bar and net assembly in accordance with embodiments described herein. The sliding bar and net assembly 200 may be used in any appropriate environment, such as vehicular applications, storage bins, cargo areas, compartments, cubicles, booths, stalls, and/or boxes in order to form a partition for storing cargo or other parcels. The sliding bar and net assembly 200 includes a first support bar 201 and second support bar 203 that are used for supporting respective retaining member such as net 205, 207. Although illustrated as a flexible net-like material, it should be evident to those skilled in the art that other types of materials can be used to retain cargo (not shown) within a predefined cargo area located between the support bars 201, 203. Loops 206 can be formed at the top of the retaining net 205, 207 so that the support bar 201, 203 can be threaded through each of the loops to hold up and/or support the retaining net. This allows the net to hang in a substantially vertical manner. Alternatively, an attachment sleeve, clips, or other types of mechanical fasteners can also be used to attach the net 205, 207 to the support bar 201. The lower portion of the retaining net 205, 207 can be fastened to a surface (not shown) for supporting the end cap 209, 211 as described herein.

Each end of the support bar 201, 203 is inserted into a channel formed into an end cap 209, 211. As will be described herein, each end cap 209, 211 includes a retaining area 213 formed using a slot or channel track 215 that is molded into an interior portion of the cap. This allows each end of the support bar 201, 203 to be guided by the channel track 215 through a raised and lowered range of motion. This enables parcels or other cargo to be easily retained in the interior of a cargo area while still allowing the user easy access. In order to hold the end cap into a fixed position, one or more legs 217 are used to fasten the end cap 209, 211 to a fixed surface. Although shown with support bars 201, 203 at each end of the assembly, it should be evident to those skilled in the art that variations using a single support bar with access on a single side to a cargo area are possible.

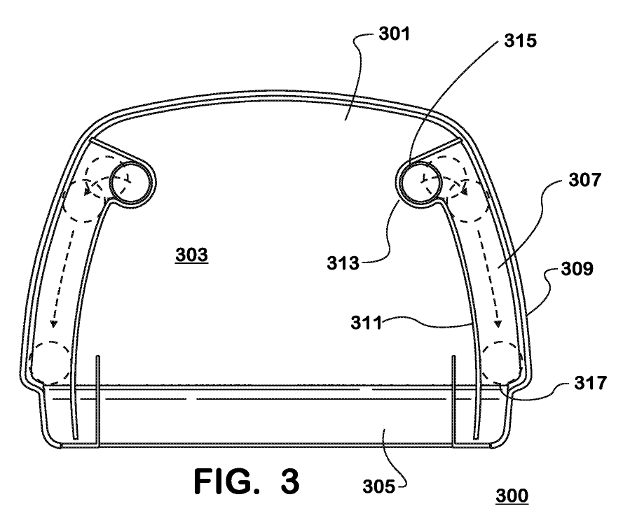

FIG. 3 is a front view of the end cap used with the sliding bar assembly. Each end cap 300 includes a main body 301 having an interior portion 303. The end cap may be injection molded from a plastic material or the like and further includes a support bridge 305 extending across a lower portion or bottom of the interior portion 303 for enhancing the overall strength of the end cap 300. At each outer edge of the interior portion 303, a channel track 307 is formed into the end cap 300. The channel track 307 is formed by the outer edge 309 of the main body 301 and a channel side 311 that extends outwardly from the surface of the interior portion 303. The channel track 307 forms an inwardly tracking arc toward the interior portion 303 so that an end of the support bar can be guided by the channel track through a raised and lowered range of motion.

At an upper end of the channel track 307, a support stop 313 is formed into the channel 307. The support stop 313 is a semicircular retention area formed integrally with the channel track 307. The support stop 313 extends inwardly within the interior portion 303 which allows the support bar to engage and/or nest within this supported area when in a raised position. The support stop 313 extends downwardly allowing a support bar to rest through its weight in this specific area without being frictionally engaged therein. The support stop 313 is sized approximately the same diameter as the support bar so that it may be easily positioned therein for holding the support bar into a substantially raised position. FIG. 3 further illustrates an end 315 of a support bar positioned within the support stop 313 in its raised position. The end 315 is also shown in phantom with downwardly pointed arrows indicating how the end 315 would move in a downward fashion within the channel 307 where it rests in its lower position against a bottom 317 of the channel track 307.

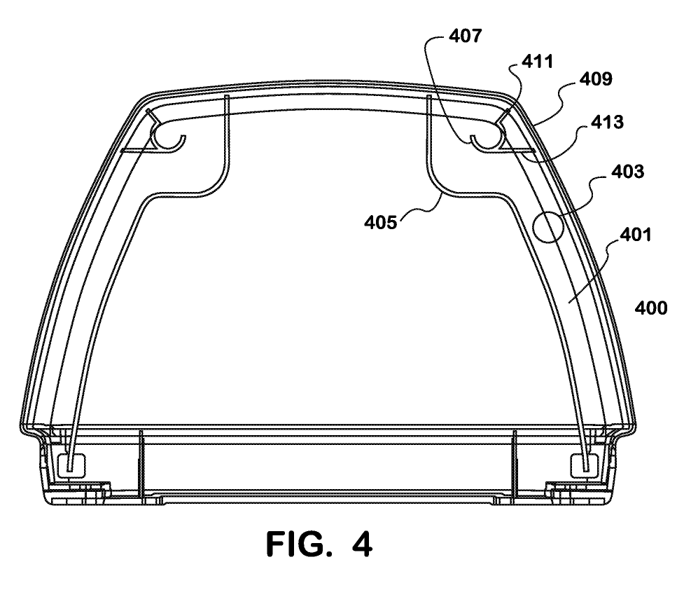

FIG. 4 is front view of the end cap 400 used with the sliding bar assembly in accordance with alternative embodiments described herein. Like the embodiment shown in FIG. 3, the end cap 400 includes a channel track 401 used for guiding a support bar 403 to a substantially raised and lowered position. The top section of the channel 401 includes an inwardly facing routing area 405 that is used to position the bar 403 to a retaining hook 407. The retaining hook 407 is upwardly faced for allowing the bar 403 to rest therein. The retaining hook 407 is attached to an outer edge 409 of the end cap 400 using a first attachment point 411 and second attachment point 413 to maintain its strength and rigidity. As will be evident to those skilled in the art, although the end cap 400 has been described with regard to a single channel track 401, a second channel track can also be used at the opposite side of the end cap 400 which operates in a similar manner.

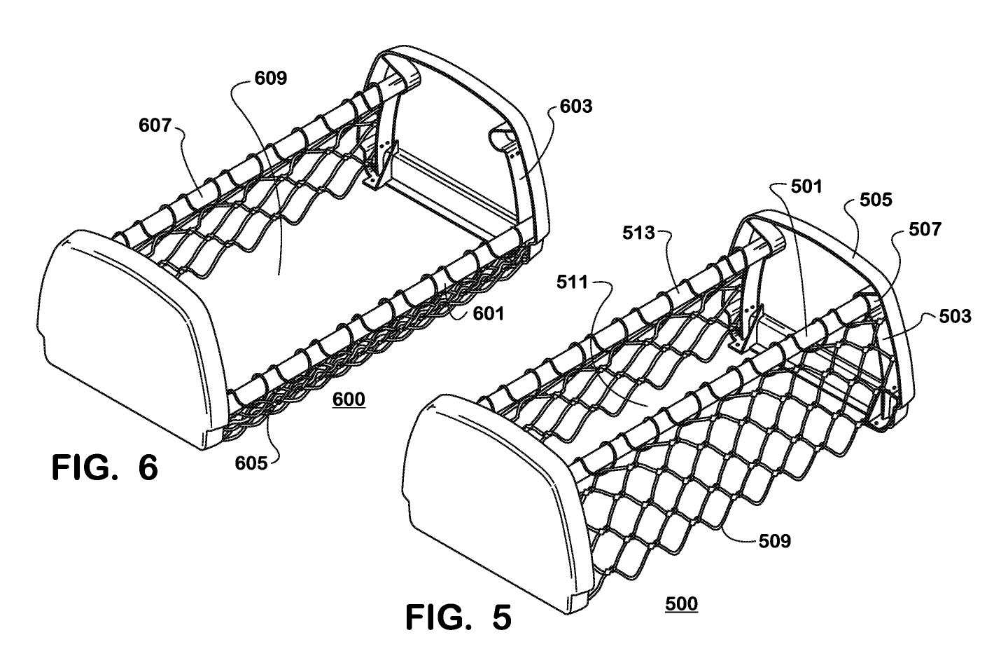

FIG. 5 is a perspective view illustrating the sliding bar and net assembly shown in a substantially raised position. The sliding bar and net assembly 500 is shown with two support bars. In a raised position, a support bar 501 is positioned at the upper end of channel track 503 in end cap 505 so that its end rests within the support stop 507. This enables the net 509 to be held in a fixed position allowing it to block items from entering or exiting the cargo area 511. The support bar 513 at the back side of the cargo area operates in a similar manner.

FIG. 6 is a perspective view illustrating the sliding bar and net assembly shown in a substantially lowered position. The sliding bar and net assembly 600 is again illustrated using two support bars with the front support bar 601 lowered so that it rests at a lower portion of the channel track 603. The net 605 is shown in a collapsed position where it bunches or folds upon itself. This rear support bar 607 can remain raised or lowered allowing access to the cargo area 609.

Thus, embodiments described herein define a retaining bar storage bin assembly for use in a vehicle, such as a truck cab or the like. The storage bin assembly includes a first end cap covering at least an end portion of the storage bin and a second end cap covering at least an end portion of the storage bin. One or more support bars extend between a first end cap and a second end cap and work to support the net or other retaining member that is used for blocking access to the storage bin. The first end cap and second end cap each includes a first channel track for allowing the retaining bar to be raised and lowered allowing easy access to a cargo area used within the vehicle.

1. A sliding bar assembly for use in cargo storage applications, the sliding bar assembly comprising:
a plurality of end caps;
at least one support bar extending between the plurality of end caps;
a retaining member attached to the at least one support bar for retaining cargo within a storage area behind the retaining member; and
wherein the plurality of end caps include at least one channel track for guiding the at least one support bar between a substantially raised position and a substantially lowered position.

2. The sliding bar assembly as defined in claim 1, wherein the retaining member is a net.

3. The sliding bar assembly as defined in claim 1, further comprising:
a support stop positioned within the at least one channel track for allowing the at least one support bar to rest in the substantially raised position.

4. The sliding bar assembly as defined in claim 3, wherein the support stop is a substantially semi-circular support space integral with the at least one channel track.

5. The sliding bar assembly as defined in claim 1, wherein each of the plurality of end caps includes a second channel track for allowing access to opposite sides of the storage area.

6. The sliding bar assembly as defined in claim 1, wherein the storage area is located within a truck cab.

7. An assembly of a retaining bar and a storage bin, the assembly for use in a vehicle, the assembly comprising:
a first end cap covering at least an end portion of the storage bin;
a second end cap covering at least an end portion of the storage bin;
a support bar extending between the first end cap and the second end cap;
a net fastened to the retaining bar for blocking access to the storage bin; and
wherein the first end cap and the second end cap each include a first channel track for allowing the retaining bar to be raised and lowered to allow access to the storage bin.

8. The assembly as defined in claim 7, wherein the first channel track includes a support stop for allowing the retaining bar to be retained in a raised position.

9. The assembly as defined in claim 7, wherein the retaining bar includes an end cap for allowing the retaining bar to ride within the first channel track.

10. The assembly as defined in claim 7, wherein the first end cap and the second end cap each include a second channel track opposite the first channel track for allowing access to the storage bin from opposite sides of the storage bin.

11. The assembly as defined in claim 7, wherein the vehicle is a truck.

12. A vehicular retaining bar storage bin assembly for use in retaining objects within a storage area, the vehicular retaining bar storage bin assembly comprising:
at least one support bar having an end;
a plurality of end caps positioned at the end of the at least one support bar, at least one channel track molded in each of the plurality of end caps, the at least one channel track guiding the at least one support bar between a substantially raised position and a substantially lowered position;
a net attached to the at least one support bar for retaining cargo within the storage area behind the net; and
a support stop positioned at an upper end of the at least one channel track for allowing the at least one support bar to be retained in the substantially raised position.

13. The vehicular retaining bar storage bin assembly as defined in claim 12, wherein the support stop is a substantially semi-circular support space formed integrally with the at least one channel track.

14. The vehicular retaining bar storage bin assembly as defined in claim 12, wherein each of the plurality of end caps includes a second channel track for allowing access to opposite sides of the storage area.

15. The vehicular retaining bar storage bin assembly as defined in claim 12, wherein the storage area is located within a truck cab.
